(19) United States
(12) Patent Application Publication
(10) Pub. No.: US 2006/0043906 A1
(43) Pub. Date: Mar. 2, 2006

(54) Driving-circuit module for connecting to a christmas light string

(76) Inventor: Jin Rong Chang, Chu-Pei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/926,962

(22) Filed: Aug. 27, 2004

(51) Int. Cl. H05B 37/02

(52) U.S. Cl. 315/224

(57) ABSTRACT

A driving-circuit module for connecting to a Christmas light string includes electrically connected voltage-retrieving unit, rectification unit, voltage-stabilizing unit, regulating unit, and noise-eliminating unit. The driving-circuit module may replace a bulb on the light string to retrieve the specific voltage and amperage from the light string no matter what number of bulbs are connected to the light string, and to rectify and stabilize the retrieved voltages to output a stable voltage, enabling a luminescent sheet, a color changeable light-emitting diode, sound producing element, small vibration generating motor, or other suitable product associated with the driving-circuit module to externally connect to an empty bulb seat on the light string to increase the practical value of the light string without adversely affecting the illuminating thereof.

### FIELD OF THE INVENTION

The present invention relates to a driving-circuit module for connecting to a Christmas light string, and more particularly to a driving-circuit module that could be connected to a Christmas light string to retrieve any voltage and amperage of an individual bulb on the light string and output a stable voltage to stably drive an externally connected light, sound, or vibration producing element associated with the driving-circuit module and connected to a bulb seat on the light string.

### BACKGROUND OF THE INVENTION

A conventional Christmas light string uses resistance wires or only light-emitting diodes to serially connect a plurality of bulbs. Light strings with different numbers of bulbs have different voltages and amperages for the bulbs thereof. For instance, in light strings of 120V separately including 10, 20, 35, and 50 bulbs, each bulb of these light strings has a voltage of 12V, 6V, 3.4V, and 2.4V, respectively; and in light strings of 240V separately including 10, 20, 35, and 50 bulbs, each bulb of these light strings has a voltage of 24V, 12V, 6.8V, and 4.8V, respectively. And, the bulbs used in the above light strings with different numbers of bulbs have different amperages depending on the bulb specifications, and may include 170 mA, 150 mA, 130 mA, 110 mA, 80 mA, 40 mA, etc. Therefore, the bulbs used in a conventional Christmas light string have voltage and amperage varied with the number of bulbs to be included in the light string, and the bulbs of two light strings having different numbers of bulbs could not be exchanged for use. Under this condition, it is impossible to change or increase the value of the conventional Christmas light strings by externally connecting them with other elements, such as luminescent sheets, color-changeable light-emitting diodes, sound producing elements, small vibration generating motors, etc., that require a fixed and stable voltage.

Since the above-mentioned luminescent sheets and color-changeable light-emitting diodes must be driven by a fixed voltage, it is necessary to use an additional external power source, such as a battery or an adapter that directly converts the public power of 120V or 240V into direct current having a low voltage, such as 3V, 4.5V, 5V, or 6V, to enable the luminescent sheets and color-changeable light-emitting diodes to externally connect to the Christmas light string. It is, of course, troublesome and expensive to do so, and the utility of the Christmas light string is reduced.

### SUMMARY OF THE INVENTION

A primary object of the present invention is to provide a driving-circuit module for connecting to a Christmas light string to retrieve any voltage and amperage from the light string no matter what number of bulbs are connected to the light string, and output a stable voltage for driving an externally connected luminescent sheet, color-changeable light-emitting diode, music/sound producing element, small vibration generating motors or the like, that requires a fixed and stable voltage, making the light string versatile and more practical and valuable for use.

To achieve the above and other objects, the driving-circuit module of the present invention mainly includes electrically connected voltage-retrieving unit, rectification unit, voltage-stabilizing unit, regulating unit, and noise-eliminating unit. The driving-circuit module may replace a bulb on the light string to retrieve any voltage and amperage from the light strings no matter what number of bulbs are connected thereto, and to rectify and stabilize the retrieved voltages to output a stable voltage, enabling a luminescent sheet, a color changeable light-emitting diode, sound producing element, small vibration generating motor, or other suitable product associated with the driving-circuit module to externally connect to a bulb seat on the light string without adversely affecting the illuminating of the light string.

In the driving-circuit module of the present invention, the voltage-retrieving unit includes a resistor connected in parallel to a power source of any bulb on the Christmas light string, so as to retrieve a voltage that is higher than that to be output by the driving-circuit module. Alternatively, the resistor is connected to and located behind the rectification unit.

The rectification unit is either one single bridge rectifier or a bridge rectifying circuit formed from four serially and parallelly connected diodes for converting the retrieved AC voltage into a DC voltage.

The regulating unit includes a voltage-stabilizing IC, and two capacitors parallelly connected to the voltage-stabilizing IC for assisting in stabilizing a voltage in the circuit, such that a nominal voltage exceeding the voltage at the voltage-stabilizing IC is eliminated.

The noise-eliminating unit includes a capacitor to filter off noises in the retrieved voltage to increase the quality of the output voltage.

The voltage-stabilizing unit includes a voltage-stabilizing IC for providing a stable output voltage, and to serve as a current limiter.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of the present invention;

FIG. 2 is a circuit diagram according to a first preferred embodiment of the present invention;

FIG. 2 is a circuit diagram according to a second preferred embodiment of the present invention;

FIG. 4 is a circuit diagram according to a third preferred embodiment of the present invention;

FIG. 5 schematically shows a Christmas light string;

FIG. 6 shows an embodied example of the driving-circuit module of the present invention;

FIG. 7 is a partially exploded view schematically showing the connection of bulbs and of sound/light emitting units associated with the driving circuit modules of the present invention to a Christmas light string; and

FIG. 8 is an assembled view of FIG. 7.

### DETAILED DESCRIPTION OF THE PREFERRED EMBODIMENTS

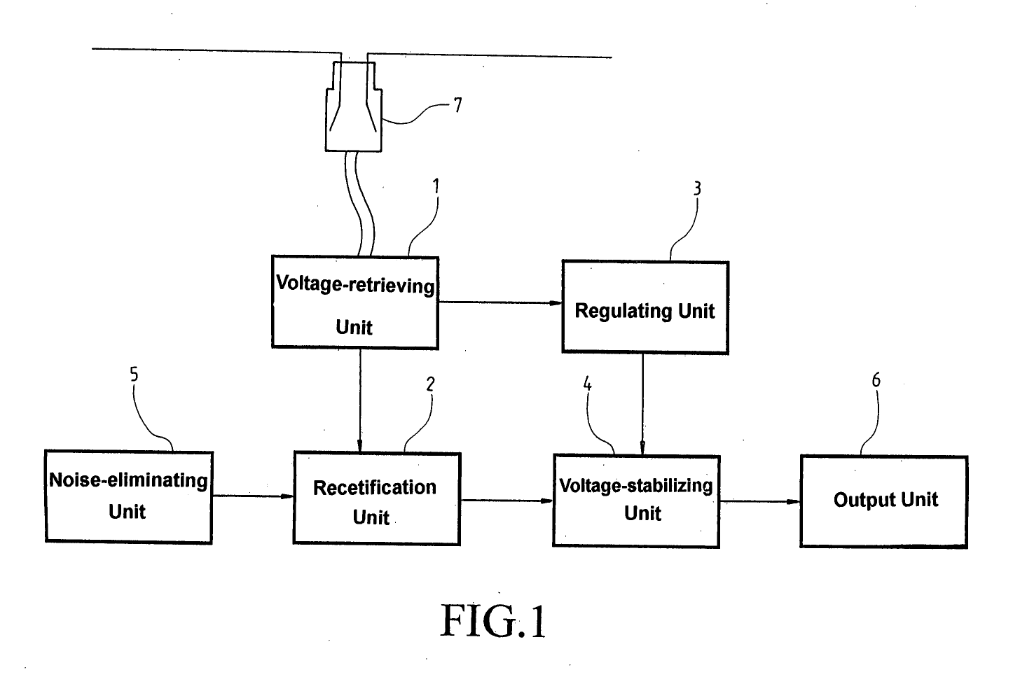

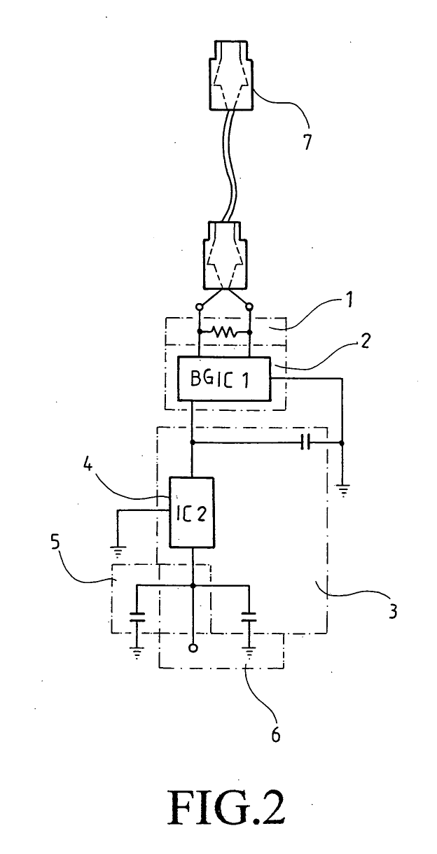

Please refer to FIG. 1 that is a block diagram of a driving-circuit module of the present invention, and to FIG. 2 that is a circuit diagram of a first preferred embodiment of the present invention. As shown, the driving-circuit module of the present invention mainly includes a voltage-retrieving unit 1, a rectification unit 2, a regulating unit 3, a voltage-stabilizing unit 4, a noise-eliminating unit 5, and an output unit 6 that are electrically connected to constitute a driving circuit module.

The voltage-retrieving unit 1 includes a resistor R1 connected in parallel to an AC power supply of a bulb seat 7 on a Christmas light string, so as to retrieve a voltage that is higher than an output of the driving-circuit module of the present invention.

The rectification unit 2 is electrically connected to the voltage-retrieving unit 1 and includes a bridge rectifier BGIC1 for converting the retrieved AC power supply into a DC power supply.

The regulating unit 3 includes a voltage-stabilizing IC2, and capacitors C1, C2 parallelly connected to the IC2, so that a voltage exceeding that at the voltage-stabilizing IC2 is eliminated from the circuit of the present invention. That is, the two capacitors C1, C2 assist in stabilizing the voltage in the circuit.

The voltage-stabilizing unit 4 is a voltage-stabilizing IC2 adapted to increase stable output voltage of the present invention, and serves to limit current.

The noise-eliminating unit 5 is a capacitor C3 for filtering off noises in the retrieved voltage to increase the quality of the output voltage.

The output unit 6 is adapted to provide a stable voltage for a luminescent sheet, a color-changeable light-emitting diode, a music/sound producing element, a small vibration-generating motor, or other suitable product to externally connect to the light string.

Please refer to FIG. 3 that shows a rectification unit 2 according to a second preferred embodiment of the present invention. In this second preferred embodiment, the rectification unit 2 is a bridge rectifying circuit consisting of four serially and parallelly connected diodes D1, D2, D3, and D4 to provide the same bridge-rectifying effect as that provided by the BGIC1 in the first preferred embodiment of the present invention shown in FIG. 2.

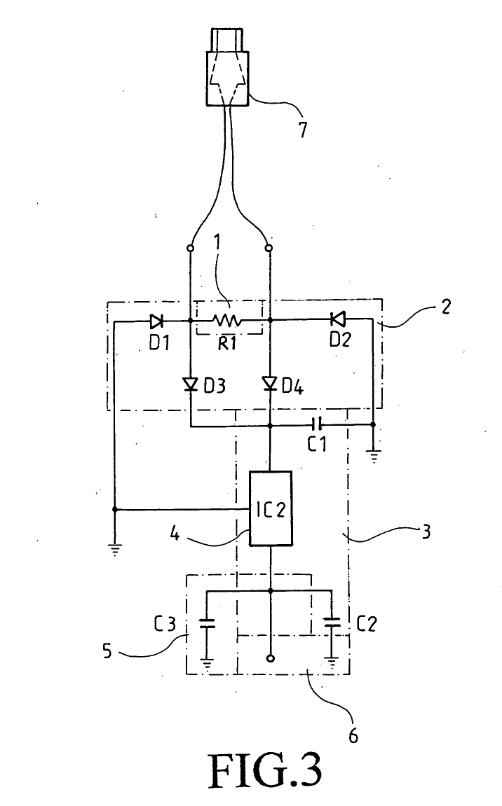

Please refer to FIG. 4 that shows a circuit diagram of a third preferred embodiment of the present invention. In the third preferred embodiment, the voltage-retrieving unit 1 has a resistor R1 connected to and located behind the rectification unit 2 to function equally well as the first preferred embodiment in retrieving a voltage higher than an output of the driving-circuit module of the present invention, and the capacitor C1 of the regulating unit 3 for assisting in stabilizing voltage is replaced with a diode D5 to provide the same good effect.

With the above arrangements, the driving-circuit module of the present invention works to convert a specific voltage of a bulb on the Christmas light string into a stable low voltage for driving a luminescent sheet, a color-changeable light-emitting diode, a music-producing element, a small vibration-generating motor, or other suitable product externally connected to the Christmas light string to increase the value of the light string without adversely affecting the intended illuminating function thereof. Moreover, the driving-circuit module of the present invention enables removal of any bulb from a bulb seat at any position on any light string having any number of bulbs, and connection of any of the above-mentioned external products to the bulb seat without adversely affecting the initial lighting effect of the light string or the effect of the present invention in driving the externally connected products.

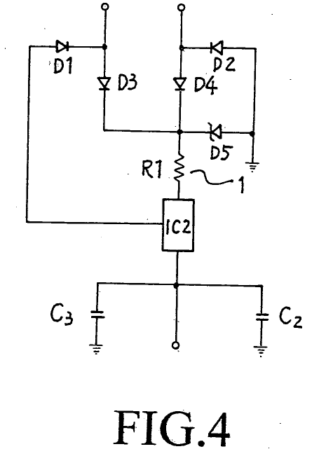

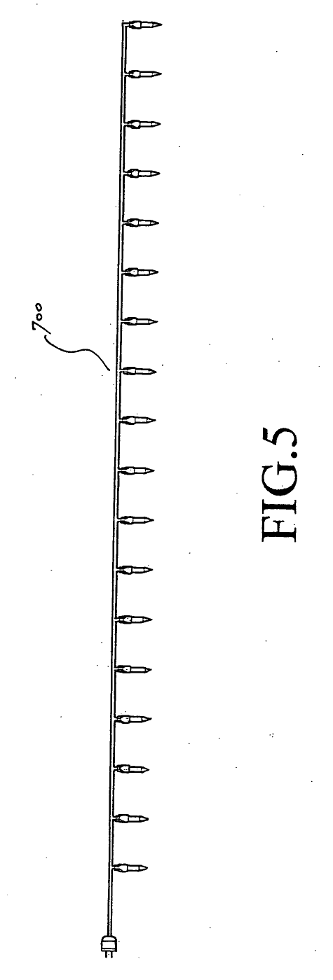

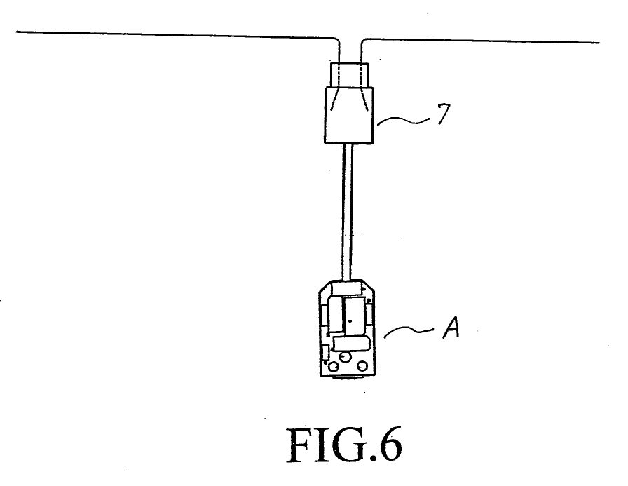

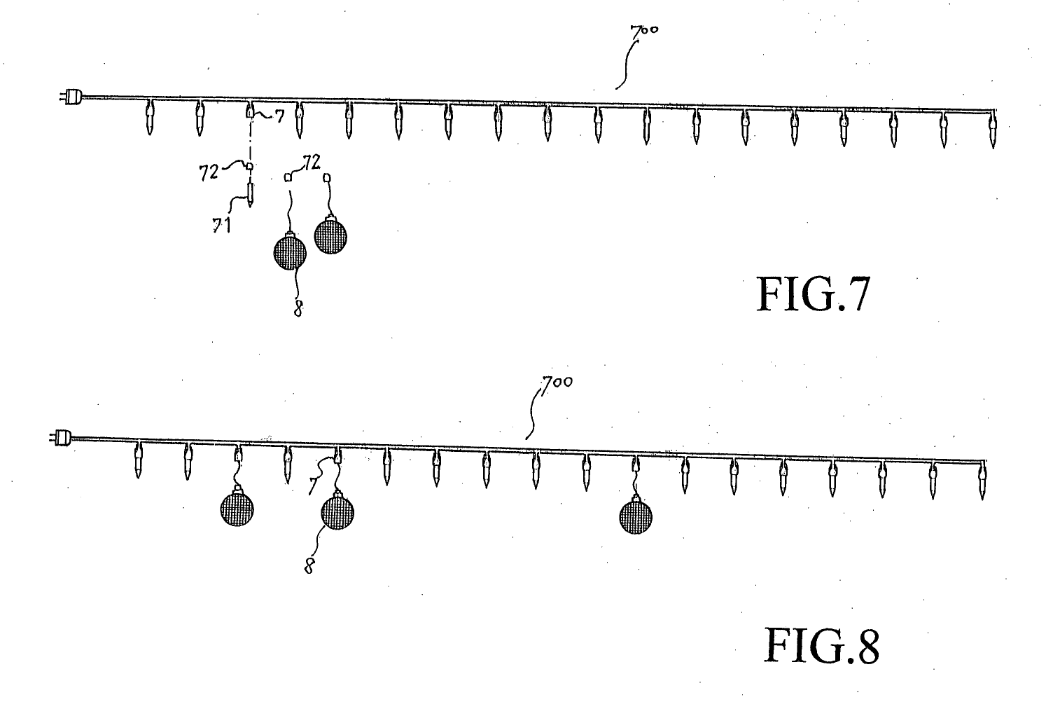

Please refer to FIG. 5 that shows a Christmas light string 700 including a plurality of small bulbs connected in series. FIG. 6 shows an embodied example A of the driving-circuit module of the present invention. FIGS. 7 and 8 are exploded and assembled views, respectively, showing the forming of a Christmas light string 700 by connecting bulbs 71 to bulb holders 72 to form a plurality of bulb assemblies, and connecting the bulb assemblies to bulb seats 7, which are serially connected on the light string 700. When it is desired to externally connect a number of other desired elements 8, such as, for example, luminescent sheets, color-changeable light-emitting diodes, or sound producing elements, to the Christmas light string 700, a user may first associate such desired elements 8 with the driving-circuit modules of the present invention, remove the same number of bulb assemblies from selected bulb seats 7 of the Christmas light string 700, and then connect the external elements 8 to the selected bulb seats 7. By doing this, the Christmas light string 700 has not only bulbs 71 to illuminate, but also other sound or light producing elements 8 to provide special sounding and/or lighting effect.

What is claimed is:

1. A driving-circuit module for connecting to a Christmas light string, comprising:
a voltage-retrieving unit including a resistor connected in parallel to a power connecting line of said Christmas light string, so as to retrieve an AC voltage that is higher than an output of said driving-circuit module;
a rectification unit being electrically connected to said voltage-retrieving unit for converting said retrieved AC voltage into a DC voltage;
a regulating unit including a voltage-stabilizing IC, and capacitors parallelly connected to said voltage-stabilizing IC for assisting in stabilizing a voltage in said driving-circuit module, such that a voltage exceeding that at said voltage-stabilizing IC is eliminated from said driving-circuit module;
a voltage-stabilizing unit including a voltage-stabilizing IC for providing a stable output voltage; and
a noise-eliminating unit for filtering off noises in said retrieved voltage to increase the quality of an output voltage;
whereby said driving-circuit module enables a luminescent sheet, a light-emitting diode, a music/sound producing element, a small vibration generating motor, or other suitable sound/light producing product associated therewith to externally connect to said Christmas light string.

2. The driving-circuit module for connecting to a Christmas light string as claimed in claim 1, wherein said rectification unit consists of a bridge rectifier and capacitors electrically connected to said bridge rectifier.

3. The driving-circuit module for connecting to a Christmas light string as claimed in claim 1, wherein said rectification unit consists of four serially and parallelly connected diodes, and capacitors electrically connected to said diodes.
